(19) United States
(12) Patent Application Publication
(10) Pub. No.: US 2010/0082653 A1
(43) Pub. Date: Apr. 1, 2010

(54) EVENT MEDIA SEARCH

(76) Inventor: Rahul Nair, Sunnyvale, CA (US)

Correspondence Address: HICKMAN PALERMO TRUONG & BECKER LLP/Yahoo! Inc., 2055 Gateway Place, Suite 550, San Jose, CA, 95110-1083, US

(21) Appl. No.: 12/240,862

(22) Filed: Sep. 29, 2008

(51) Int. Cl. G06F 17/30

(52) U.S. Cl. 707/759; 707/E17.017

(57) ABSTRACT

In response to a request to search for media items, one or more gather terms and one or more filter terms are determined. Based on the one or more gather terms, a first set of media items is identified. A set of metadata associated with media items that belong to the first set of media items is identified. Based on the one or more filter terms, a set of qualifying metadata and a set of disqualifying metadata are established from the set of metadata. A second set of media items that are associated with metadata that include terms that satisfy matching criteria for one or more metadata from the set of qualifying metadata and do not satisfy matching criteria for any metadata from the set of disqualifying metadata is determined. The request is responded to with search results based on the second set of media items.

### FIELD OF THE INVENTION

Tools and techniques described herein relate to searching media items. In particular, the tools and techniques relate to searching media items associated with events.

### BACKGROUND

Access to electronic media information has grown exponentially over the years. More and more websites allow users to share, download, or stream music, pictures, videos, and other media. Mass storage devices store more information in less space than ever before, making it easier to transport large quantities of media. Moreover, access to networks, particularly the Internet, has improved as connection speeds have increased and wireless capabilities have improved. Electronic devices such as personal media players (PMPs), cell phones, game consoles, laptop computers, and personal digital assistants (PDAs) have also contributed to the rising demand for quicker and better access to media content.

Because of the vast amount of media content available, methods for organizing, searching and sorting the information are important. One method for organizing and classifying data is through metadata such as tags. With the rise in popularity of social networking sites, many users tag media items with one or more keywords or terms that help to describe the item. Because such tags are generally user-defined, they are often informal. Moreover, some sites allow collaborative tagging, where multiple users may tag the same media item with different tags.

An “event” is something that occurs at a particular place and time. Events include, for example, birthday parties, concerts, final exams, etc. Many web sites allow users to define, tag, and invite others to events. For example, a user of such a web site may define a concert event. The user may tag the concert event with:

An event name

a description

an artist

location information

time and date information

price information, etc.

To make full use of the information contained in the tags, some systems employ mechanisms to identify and “extract” particular types of information. For example, a system may include mechanisms for identifying artists, locations, etc. When a user tags an event with information (“tag data”), the system may use those mechanisms to see if the tag data includes the name of an artist, or the name of a place. If the tag data includes the name of an artist, then the system may store metadata that associates the artist with the event. Similarly, if the tag data includes the name of a location, then the system may store metadata that associates the location with the event.

Search engines can make use of such tags and metadata in order to find, rank, and/or return items. Traditional searches attempt to return relevant information in response to a request from the user. This request usually comes in the form of a query (e.g., a set of words that are related to a desired topic). A common way of searching for media is to find web pages or media items containing all or many of the words included in the query. Such a method is typically referred to as text-based searching. For example, assume that a user is interested in seeing photos taken at a concert in which an artist_X performed at a location_Y on a day_Z. To find the photos, the user may submit a search query with the terms “artist_X and location_Y and day_Z”.

Search engines typically respond to such a query by returning a display of links associated with web pages (or media items) and a brief description of the content provided by the web pages (or media items). However, purely text-based searches may be over-inclusive and/or under-inclusive in their results. For example, text-based searches may overlook certain items that do not contain some or any of the search terms, but which should nevertheless be included in the search result. For example, artist_X may have a nickname Q. A search based on “artist_X and location_Y and day_Z” may not match a photo that has been tagged with artist Q, location_Y and day_Z. In practice, entities such as artists and locations tend to have several different acceptable names. For example, different users may tag a concert that took place in Berkeley, Calif. with “Berkeley”, “Bay Area” and/or “San Francisco”. While the “San Francisco” tags for a Berkeley concert are technically inaccurate, such approximations are common in user-driven tagging environments.

To avoid being under-inclusive the search logic may be changed. For example, a search may be performed based on “artist_X or location_Y or day_Z”. However, such a search will inevitably be over-inclusive. For example, the result set of “artist_X or location_Y or day_Z” may include photos that were not taken at the concert in question, but were tagged with X, Y or Z for other reasons. As a result, searching for media items based on text matching alone will often produce suboptimal results.

### BRIEF DESCRIPTION OF THE DRAWINGS

Embodiments are illustrated by way of example, and not by way of limitation, in the figures of the accompanying drawings and in which like reference numerals refer to similar elements and in which:

FIG. 1 is a flowchart illustrating steps for searching for media items, in accordance with an embodiment of the invention.

FIG. 2 illustrates an exemplary display depicting results from a search request for an event, in accordance with an embodiment of the invention.

FIG. 3 is a block diagram that illustrates a computing device upon which an embodiment of the invention may be implemented.

### DETAILED DESCRIPTION

In the following description, for the purposes of explanation, numerous specific details are set forth in order to provide a thorough understanding of the present invention. It will be apparent, however, that embodiments of the invention may be practiced without these specific details. In other instances, well-known structures and devices are shown in block diagram form in order to avoid unnecessarily obscuring embodiments of the invention.

### OVERVIEW

Techniques are described herein for searching for media items using tags and metadata. While user-generated tags are used throughout the following description as a source of metadata for media items, user-generated tags are merely one source from which media item metadata may be obtained. Other sources of media item metadata may include, for example, automatically extract keywords from media titles and descriptions. The techniques described hereafter may be performed using metadata from such other sources in conjunction with, or instead of, user-generated tags.

In one embodiment, the search terms are divided into two sets: “gather terms” and “filter terms”. Initially, a search is performed using the gather terms without using the filter terms. Because the filter terms are not used to restrict the initial search, the results of the initial search will tend to be over-inclusive relative to the domains of the filter terms. The results of the initial search are referred to herein as the first-phase results.

For example, if the query is “artist_X, location_Y, day_Z”, then the search terms may be divided into gather terms “artist_X and day_Z” and filter term “location_Y”. Based on this division, the initial search is performed based on “artist_X and day_Z”. The initial search is intended to be overinclusive, so the search terms in some domains may be intentionally expanded. For example, rather than perform the initial search based on a specific day, the initial search may be expanded to cover a time period surrounding the specified day. Thus, even though the gather terms include day_Z, the initial search may be based on time_period_Z, which may include one week before day_Z and three weeks following day_Z.

Because location_Y is not used to perform the initial search, and some of the gather terms were broadened, the initial search results will tend to have some results that are associated with location_Y, and other results that are associated with other locations. For example, the results of the search for “artist_X and day_Z” may match photos of concerts of artist_X at many other locations within the time_period_Z.

Once the first-phase results are identified, the filter terms are used to categorize the tags that are associated with first-phase results. Specifically, tags that frequently co-occur, within the first-phase results, with the filter terms are established as “qualifying tags”. On the other hand, tags that frequently co-occur with tags that contradict the filter terms are established as “disqualifying tags”.

For example, assume that the search results for “artist_X and day_Z” includes 1000 photos. Assume that 500 of those photos are tagged with location_Y and event_name_A. Assume the other 500 of those photos are tagged with location_F, event_name_B. Further assume that location_F is unambiguously different from location_Y. Under these circumstances, event_name_A would be established as a “qualifying tag” because it frequently co-occurs with the filter term. On the other hand, event_name_B would be established as a “disqualifying tag” because it frequently co-occurs with a tag that contradicts the filter term.

After the qualifying tags and disqualifying tags have been identified, a subsequent search may be performed based at least in part on the qualifying tags and/or the disqualifying tags. For example, a subsequent search may be performed in which event_name_A is used as one of the search terms. Similarly, “not event_name_B” may be used to as one of the search conditions.

### Media Associated with Events

The techniques described herein facilitate searching, sorting through, and organizing media items, especially media items related to an event. In this context, an “event” may be anything with at least one associated location and at least one associated time period. Accordingly, example events include, but are not limited to: music concerts, festivals, group gatherings, sporting games or competitions, speeches, comedy performances, and theater or other visual arts performances. In one embodiment, the specific structure and metadata about the event is used to build up a model of metadata that uniquely identifies the event in question and also identifies metadata that identify different events.

In another scenario, the techniques described herein help searching for media related to an event by taking advantage of location information associated with the event. Since many databases provide location information about an event, one embodiment advantageously uses the location information to build a model and establish a set of qualifying tags and disqualifying tags. Such techniques automatically search and find event media using only minimal event information that can be found on user-generated sites.

Moreover, techniques help overcome problems with simple text-based searching by finding lists of tags that apply to a media item in question, even if those tags may not have been present in the original description involved in the search for the media item. These techniques are especially useful when the model uses user-generated descriptions.

The techniques may be implemented by a desktop application on a computer or other computing device (e.g. as a customized web browser), or by a combination of server-based and client-based tools, or by other methods.

### Obtaining Search Terms

As mentioned above, techniques are provided for searching media items by building a model using tags and metadata. The media search engine receives one or more search terms and returns, as output, search results that include, identify and/or link to media items. In one embodiment, the media search engine takes information that identifies an event (an “event ID”) as its input parameter and returns a list of images and videos that were taken at the event.

The search terms for a media search may be manually specified by a user. However, to lesson the burden on the user, embodiments of the invention are provided in which search terms are extracted from various sources based on input received from a user. For example, the user may simply enter an event ID. The system may use the event ID to obtain search terms from various sources, and the search terms may then be divided into gather and filter terms, as described above.

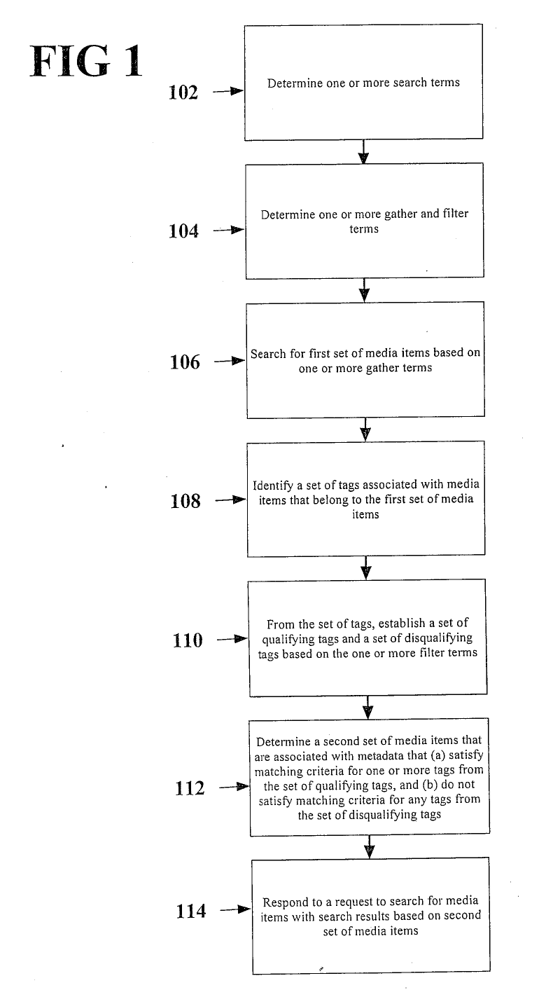

Referring to FIG. 1, it illustrates steps for performing a search, according to an embodiment of the invention. As illustrated in FIG. 1, the media search engine determines one or more search terms 102. The search terms may be, for example, search terms entered by a user through a search interface. The search terms may be provided explicitly as input parameters or may be extracted based on the input parameters. For example, the input parameter may consist of an event ID, which is a number associated with a real world event. The event ID may be used by the system to extract detailed information about the event, such as its name, location, and date, from a repository of event information.

In one embodiment, information relating to an event is extracted and used in the search for media items. Event information may be extracted from one or more databases. For example, detailed event information may be stored in websites. The detailed information may include, among other things, location information, such as the venue and city names associated with an event. This detailed information may be extracted, based on one or more search terms provided by a user, from various available event-related sites and databases, such as Upcoming.org. However, the present techniques are not limited to any particular event-related site or database.

Location information from an event-related site is likely to be at least approximately accurate, and therefore is a good candidate for use as a filter term. However, location information is merely one example of information that can be used as search terms (either as “gather” or “filter” terms). Many other types of information that may be extracted from event-related sites, and used as search terms. For example, in a search for a music concert event, the concert may be named after a tour, or non-headlining bands or band names may be named only in the description. In order to extract information in these scenarios, the combination of the event title and the event description may be fed through a content extraction mechanism which returns a set of key phrases and concepts with input text. These key phrases and concepts with input text, in turn, may be used as search terms to find media related to the event.

According to one embodiment, the content extractor also attempts to classify the phrases into categories such as music bands, locations, etc. For example, in the case of a music concert, the name of an artist may be extracted through the Yahoo Music Artist Search API. Each of the phrases returned by the content extractor is sent through the Artist Search API to see if there are any results returned. If there is an exact match, that term is then added to the list of artists performing at the concert. The method may need to look at context to distinguish between common phrases, or locations, that also double as artist names (e.g. Chicago).

After the search terms have been obtained, the search terms are divided into gather terms and filter terms (step 104). In one embodiment, location information is used as the filter term. Various sources contain detailed location information, and extracting location information for an event will likely be accurate. Furthermore, on user-generated websites, many users tag media items with location information. Therefore, location information related to an event may advantageously be used as a filter term in building the model and constructing tags.

### Media Collection—the Initial Search

As indicated above, the one or more gather terms and the one or more filter terms may be extracted from a source (such as an events database) or may be explicitly provided by a user. Referring again to FIG. 1, after the gather and filter terms have been determined, a search is performed for a first set of media items based on the one or more gather terms 106. According to one embodiment, the search begins with trying to collect as many media items based on the one or more gather terms as possible. This can be done by running a series of searches on various databases and websites.

To increase the result set of the initial search, search terms may be expanded or broadened. For example, “ELO” may be expanded to “‘ELO’ OR ‘Electric Light Orchestra”’. As another example, “Berkeley” may be expanded to include any location within 200 miles of Berkeley. As yet another example, May 8, 2007 may be expanded to include “May 1, 2007 to May 21, 2007”.

In one embodiment, a time associated with an event is included in the one or more gather terms. Only media items that were created or uploaded roughly around the time of the event are included in the first set of media items. For example, the time included as a gather term may be compared to the time the media item was recorded or the time that the media item was uploaded. The time the media item was recorded may be inaccurate because many people do not update the date on their cameras. Accordingly, it is advantageous to consider both times when using time as a gather term. Other gather terms, such as the location or name of an event, may also be used in crawling for media items and creating the first set of media items.

The media items that are returned in the initial search are based on the one or more gather terms, and are referred to herein as the “first-phase results”. For example, a search for media items related to a music concert may include single or separate searches for the name of the tour, the name of the artists playing at the concert, and other terms describing the event. Any media items that match the search criteria are included in the first-phase results.

### Search Assumptions

In one embodiment, for searches for photographs taken at a concert event, the media search engine relies on the following assumptions during the initial search: (1) the artists will play at only one event in a city per visit; (2) if the artist does play multiple nights then the sets are likely to be close enough that end users won't mind seeing the photos or videos from any of the nights; (3) the photos cannot be uploaded before the event and will be uploaded before the next concert by the same artists at the same venue (a window of a few months); (4) the photos will usually be tagged with some sort of location/venue/festival information; (5) people who take photos at a concert take a minimum of three photographs; (6) photographers generally visit only one concert venue on tour. Depending on the properties of applicable media repository, the photos may be named or grouped (e.g. by album) with a combination of artist, venue, festival, etc. The above assumptions are given by way of example and may vary depending on implementation.

### Tag Categorization

After the first-phase results are obtained, metadata associated with media items that belong to the first-phase results are identified 108. For the purpose of explanation, it shall be assumed that the metadata is in the form of tags. However, tags are merely one example of how metadata may be associated with media items. Some metadata, such as the creation time, may be stored as metadata within the media item file itself.

From the set of tags, a set of qualifying tags and a set of disqualifying tags are established based on the one or more filter terms (110). As mentioned above, tags that are frequently co-located with the filter terms are established as qualifying tags, and tags that are frequently co-located with terms that contradict the filter terms are established as disqualifying tags.

### Generating Search Results Based on Qualifying and Disqualifying Tags

After the sets of qualifying and disqualifying tags have been established, a subsequent search may be performed to collect a second set of media items. In the subsequent search, media items are selected if the media items (a) are associated with metadata that satisfy matching criteria for one or more tags from the set of qualifying tags, and (b) do not satisfy matching criteria for any tags from the set of disqualifying tags (112).

In one embodiment, this second set of media items is returned by the media search engine as the response to the request to search for media items (114).

### EXAMPLE TAG CATEGORIZATION

For the purpose of explanation, assume that location_Y is the filter term in a search for media relating to a concert. In one embodiment, for the media items in the first-phase results, the media search engine creates a list of all the tags and their counts. Each tag that applies to more than five percent of the photos and is not on a stoplist (metal, techno, cool, stage, etc.) is run through a location engine (a.k.a. “geocoding server”) to see if the tag contains location information. If the tag refers to a location, then the media search engine determines whether the location associated with the tag is more than a threshold distance away from location_Y. If the location is more than the threshold distance away from location_Y, then the tag is added to a list of disqualifying tags that refer to events in other locations. A threshold is used because users often refer to venues by the nearest big city.

On the other hand, if the distance between the location represented by the tag and location_Y is less than a threshold distance, then the tag is added to a list of qualifying or “good” tags. Typically, the “good tags” that result from this process will include the name of the concert venue, and the city in which the concert took place. Thus, if the filter term is a location term, then the initial set of qualifying and disqualifying terms will also be location terms.

### Expanding the Qualifying and Disqualifying Sets

Once the initial qualifying and disqualifying tag lists have been constructed, the qualifying and disqualifying sets may be expanded to different types of metadata. For example, in one embodiment, the system cycles through every media item in the first-phase results. If the media item has any disqualifying tags, then: (a) the creator of the media item is added to a list of disqualifying users, (b) the media item is classified as a disqualified media item, and (c) all tags of the media item are listed as disqualifying “bad associated” tags. This usually includes the names of venues in other locations.

On the other hand, for any media items with a qualifying tag: (a) the owner is established as qualifying, (b) the media item is marked as “qualifying”, and (c) the tags of the media item are listed as qualifying tags. Media items with neither qualifying nor disqualifying tags are listed as unknown media items with unknown associated tags.

The media search engine cycles through each of the bad tags and checks if it is either a stop listed tag or on the list of good tags. If it is neither, the media items associated with the user are removed from the result set (under the assumption that the user that created the media item in a different location will not have media items relevant to the event at hand). In some cases, it may be beneficial to remove media items if the user has posted less than a threshold amount. For example, in the case of photographs, removing all photos taken by users with less than five photos can cut down on individual event photos that are randomly uploaded.

According to one embodiment, once all media items associated with disqualifying tags (and disqualified users) have been removed from the first-phase results, the media search engine returns the remaining media items of the first-phase results as the results of the search.

### Co-Occuring Tags

As mentioned above, tags that commonly co-occur with media items tagged with qualifying information may also be added as qualifying tags. Likewise, tags that commonly co-occur with media items tagged with disqualifying information may be added as disqualifying tags.

For example, in a first event a band may play in the Greek Theater in Berkeley and two days later in a second event play in the Greek in Los Angeles. Many user-generated media items may be tagged “Berkeley”, “San Francisco”, or “Bay Area.” In building a model for the first event, the media search engine may use “Berkeley” as a reference location and determine “San Francisco” and “Bay Area” are also qualifying tags containing location information. Furthermore, “Los Angeles” may be added as a disqualifying tag. “Greek Theater” may be added as a qualifying tag because it commonly co-occurs with the tag “Berkeley.” Similarly, “The Greek” may be added as a disqualifying tag because it commonly co-occurs with the tag “Los Angeles.”

### Expanding the Search

Certain sites that host media content may not have extensive sets of tags, or any tags at all. Therefore, it may be advantageous to use that tags on media items from an extensively-tagged site to generate the sets of qualifying and disqualifying tags, and then use those sets of qualifying and disqualifying tags to search other sites that are less-extensively tagged.

For example, a set of qualifying and disqualifying tags may be established from a website X containing photos that are extensively tagged. For example, based on the tags on photos at website X, “Greek Theater” may be established as a qualifying tag and “The Greek” may be established as a disqualifying tag. As explained above, these tags may be thus classified even though neither of the terms was included as a search or filter term. Subsequently, a query using these tags may be performed to find videos at website Y. For example, a search for videos at website Y may retrieve all items containing the name of a band performing at the event and the term “Greek Theater” but excluding videos that only contain the term “Greek.”

The qualifying and disqualifying tags obtained by analyzing one type of media may be used to expand the search to other types of media. For example, the system can use the combination of the qualifying tags (determined based on metadata associated with digital photos) to search for other media, such as web pages, audio recordings, blogs, newspaper articles, etc.

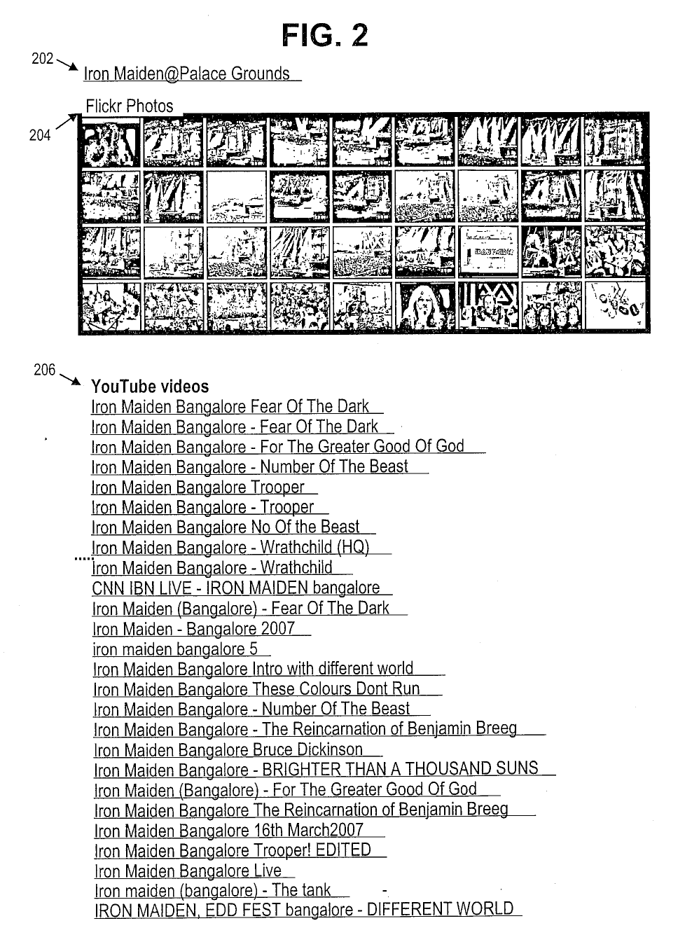

FIG. 2 shows example search results for an Iron Maiden concert in Bangalore in accordance with one embodiment of the invention. The band name “Iron Maiden” was used as a gather term while the location, “Bangalore” was used as a filter term 202. Photographs taken by various users from Flickr are returned and displayed in thumbnail format 204. Links to Youtube videos of the concert are also displayed 206.

The specific starting point at which a media search is initiated may vary from implementation to implementation. For example, in one embodiment, the media search is initiated by a user submitting a search query through a search interface. In other embodiments, the user may initiate the search for media related to an event from the page of a web site that is related to the event. In such an embodiment, the initial search terms may be extracted from the content of the page at which the search is initiated. In yet another embodiment, a query may be initiated based on a single image from an event. For example, starting with a photo of a conference venue, the system may extract the information in the photo (tags, location, time). Those extracted values may then be divided into gather and filter terms. The gather and filter terms may then be used, as described above, to search for other media items associated with the same event.

### Iterative Expansion

In the description given above, an initial set of qualifying and disqualifying tags were established, the sets were expanded based on co-location between tags, and the expanded sets of tags were used to obtain the final search results. However, it should be noted that there is no particular limit to the number of tag set expansion iterations that a media search engine may perform.

For example, assume that the filter term is location_Y. Assume that the first-phase results have location_1, location_2 and location_3, all of which fall within 200 miles of location_Y. Consequently, the qualifying tags will be expanded to include location_1, location_2 and location_3. Similarly, the first-phase results may have location_4, location_5 and location_6, each of which is more than 200 miles away from location_Y. Consequently, the disqualifying tags may be expanded to include location_4, location_5 and location_6.

After the qualifying and disqualifying sets have been initially seeded with qualifying and disqualifying locations, tags from the first-phase results may be analyzed to determine that tag_1, tag_2 and tag_3 frequently co-occur with the qualifying tags, and that tag_4, tag_5 and tag_6 frequently co-occur with the disqualifying tags. After this iteration, the qualifying set will include location_1, location_2, location_3, tag_1, tag_2, and tag_3. Similarly, the disqualifying set will include location_4, location_5, location_6, tag_4, tag_5, and tag_6.

Rather than perform a subsequent search based on these qualifying and disqualifying sets, the media search engine may perform any number of additional expansion iterations. For example, in the next expansion iteration, the media search engine will find tags that frequently co-occur with tag_1, tag_2, tag_3, tag_4, tag_5 and tag_6. Depending on the implementation, the number of expansion iterations may fixed, iterations may continue until no new tags are added to the sets, or until the sets reach some threshold size (e.g. 30 tags).

### Hardware Overview

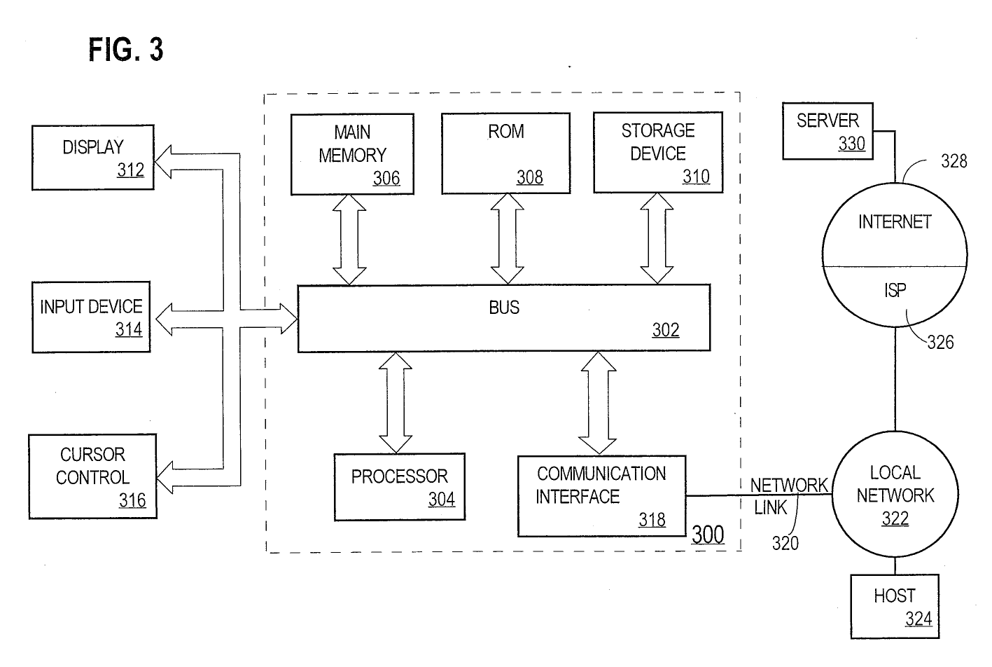

FIG. 3 is a block diagram that illustrates a computing device 300 upon which an embodiment of the invention may be implemented. Computing device 300 includes a bus 302 or other communication mechanism for communicating information, and a processor 304 coupled with bus 302 for processing information. Computing device 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computing device 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computing device 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computing device 300 for implementing the techniques described herein. According to one implementation of the invention, those techniques are performed by computing device 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative implementations, hard-wired circuitry may be used in place of or in combination with software instructions to implement the invention. Thus, implementations of the invention are not limited to any specific combination of hardware circuitry and software.

The term “machine-readable medium” as used herein refers to any medium that participates in providing data that causes a machine to operation in a specific fashion. In an implementation implemented using computing device 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computing device 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computing device 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone or cable line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computing device 300, are exemplary forms of carrier waves transporting the information.

Computing device 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computing device 300 may obtain application code in the form of a carrier wave.

Of course, this is just one example of a computing device configuration. In another embodiment, the computing device configuration might be different. In one embodiment, the computing device is a computer system, a personal digital assistant, cell phone, etc.

In the foregoing specification, implementations of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for searching for media items, the method comprising the steps of:
in response to a request to search for media items, determining one or more gather terms and one or more filter terms;
based on the one or more gather terms, identifying a first set of media items;
identifying a set of metadata associated with media items that belong to the first set of media items;
based on the one or more filter terms, establishing from the set of metadata a set of qualifying metadata and a set of disqualifying metadata;
determining a second set of media items that are associated with metadata that include terms that (a) satisfy matching criteria for one or more metadata from the set of qualifying metadata, and (b) do not satisfy matching criteria for any metadata from the set of disqualifying metadata; and
responding to said request with search results based on said second set of media items.

2. The method of claim 1, wherein the one or more gather terms include time-specifying information associated with an event.

3. The method of claim 2, wherein the first set of media items comprises only media items having associated metadata indicating that the media item was created within a predetermined span surrounding the time indicated by the time-specifying information.

4. The method of claim 2, wherein the first set of media items comprises only items that were uploaded within a predetermined span surrounding the time indicated by the time-specifying information.

5. The method of claim 1 wherein the one or more filter terms include location-specifying information about where an event occurred.

6. The method of claim 5, wherein establishing the set of qualifying metadata and the set of disqualifying metadata comprises
within the first set of media items, identifying qualifying media items;
wherein the qualifying media items are media items associated location information that falls within a threshold distance of the location indicated by the location-specifying information;
establishing one or more metadata of the qualifying media items as qualifying metadata;
within the first set of media items, identifying disqualifying media items;
wherein the disqualifying media items are media items associated location information that falls outside a threshold distance of the location indicated by the location-specifying information; and
establishing one or more metadata of the disqualifying media items as disqualifying metadata.

7. The method of claim 1, wherein the one or more qualifying metadata include a term that is not in said one or more gather terms and is not in said one or more filter terms.

8. The method of claim 1, wherein the one or more gather terms include the name of an event.

9. The method of claim 1, wherein the one or more gather terms include location information about an event.

10. The method of claim 1, wherein at least one of the one or more gather terms is extracted from a database based on an input parameter.

11. The method of claim 1, wherein the set of qualifying metadata includes a set of qualifying tags, and the set of disqualifying metadata includes a set of disqualifying tags.

12. The method of claim 1, wherein the first set of media items are media items from a first site, and the second set of media items include media items that are not from the first site.

13. The method of claim 1, wherein the first set of media items are digital photos, and the second set of media items includes videos.

14. The method of claim 1, further comprising the step of expanding the set of qualifying metadata to include metadata that are frequently co-located with metadata that has already been established as qualifying metadata.

15. The method of claim 14, further comprising repeating the step of expanding until a particular condition is satisfied.

16. A method for searching for media items, the method comprising the steps of:
receiving a request to search for media items related to an event;
determining a reference location for the event;
using first search criteria related to the event to identify a first set of media items, wherein the first search criteria do not include the reference location;
extracting a first set of tags associated with media items in the first set of media items;
from the first set of tags, identifying a second set of tags that are associated with location information;
from the second set of tags, forming a third set of tags and a fourth set of tags;
wherein the third set of tags are tags that satisfy matching criteria relative to the reference location;
wherein the fourth set of tags are tags that do not satisfy matching criteria relative to the reference location;
using the third set of tags and the fourth set of tags to identify a second set of media items related to the event; and
responding to said request with search results based on said second set of media items.

17. The method of claim 16, wherein the step of using the third set of tags and the fourth set of tags to identify a second set of media items related to the event includes:
identifying a fifth set of tags that are co-occurring with said third set of tags; and
using the said fifth set of tags to identify media items to exclude from said second set of media items.

18. The method of claim 16, wherein the step of using the third set of tags and the fourth set of tags to identify a second set of media items related to the event includes:
identifying a fifth set of tags that are co-occurring with said fourth set of tags; and
using the fifth set of tags to identify media items to exclude from said second set of media items.

19. A method for searching for items relating to a particular subject, the method comprising the steps of:
in response to a request to search for items, determining one or more gather terms and one or more filter terms;
based on the one or more gather terms, identifying a first set of items;
identifying a set of metadata associated with items that belong to the first set of media items;
based on the one or more filter terms, establishing from the set of metadata a set of qualifying metadata and a set of disqualifying metadata;
using search terms extracted from said set of qualifying metadata to search for a second set of items relating to the particular subject; and
responding to said request with search results based on said results of said search.

20. The method of claim 19 wherein items in the first set of items are a different type of media item than items in the second set of items.

21. The method of claim 20 wherein the second set of items include at least one item selected from a set consisting of webpages, blogs, recordings, and newspaper articles.

22. A computer-readable storage medium storing one or more sequences of instructions which, when executed by one or more processors, causes the one or more processors to perform the method recited in claim 1.

23. A computer-readable storage medium storing one or more sequences of instructions which, when executed by one or more processors, causes the one or more processors to perform the method recited in claim 2.

24. A computer-readable storage medium storing one or more sequences of instructions which, when executed by one or more processors, causes the one or more processors to perform the method recited in claim 3.

25. A computer-readable storage medium storing one or more sequences of instructions which, when executed by one or more processors, causes the one or more processors to perform the method recited in claim 4.

26. A computer-readable storage medium storing one or more sequences of instructions which, when executed by one or more processors, causes the one or more processors to perform the method recited in claim 5.

27. A computer-readable storage medium storing one or more sequences of instructions which, when executed by one or more processors, causes the one or more processors to perform the method recited in claim 6.

28. A computer-readable storage medium storing one or more sequences of instructions which, when executed by one or more processors, causes the one or more processors to perform the method recited in claim 7.

29. A computer-readable storage medium storing one or more sequences of instructions which, when executed by one or more processors, causes the one or more processors to perform the method recited in claim 8.

30. A computer-readable storage medium storing one or more sequences of instructions which, when executed by one or more processors, causes the one or more processors to perform the method recited in claim 9.

31. A computer-readable storage medium storing one or more sequences of instructions which, when executed by one or more processors, causes the one or more processors to perform the method recited in claim 10.

32. A computer-readable storage medium storing one or more sequences of instructions which, when executed by one or more processors, causes the one or more processors to perform the method recited in claim 11.

33. A computer-readable storage medium storing one or more sequences of instructions which, when executed by one or more processors, causes the one or more processors to perform the method recited in claim 12.

34. A computer-readable storage medium storing one or more sequences of instructions which, when executed by one or more processors, causes the one or more processors to perform the method recited in claim 13.

35. A computer-readable storage medium storing one or more sequences of instructions which, when executed by one or more processors, causes the one or more processors to perform the method recited in claim 14.

36. A computer-readable storage medium storing one or more sequences of instructions which, when executed by one or more processors, causes the one or more processors to perform the method recited in claim 15.

37. A computer-readable storage medium storing one or more sequences of instructions which, when executed by one or more processors, causes the one or more processors to perform the method recited in claim 16.

38. A computer-readable storage medium storing one or more sequences of instructions which, when executed by one or more processors, causes the one or more processors to perform the method recited in claim 17.

39. A computer-readable storage medium storing one or more sequences of instructions which, when executed by one or more processors, causes the one or more processors to perform the method recited in claim 18.

40. A computer-readable storage medium storing one or more sequences of instructions which, when executed by one or more processors, causes the one or more processors to perform the method recited in claim 19.

41. A computer-readable storage medium storing one or more sequences of instructions which, when executed by one or more processors, causes the one or more processors to perform the method recited in claim 20.

42. A computer-readable storage medium storing one or more sequences of instructions which, when executed by one or more processors, causes the one or more processors to perform the method recited in claim 21.
